(19) United States
(12) Patent Application Publication
(10) Pub. No.: US 2006/0162665 A1
(43) Pub. Date: Jul. 27, 2006

(54) Squirrel proof platfrom bird feeder

(76) Inventor: Robert A. George, Broadalbin, NY (US)

Correspondence Address: SCHMEISER, OLSEN & WATTS, 22 CENTURY HILL DRIVE, SUITE 302, LATHAM, NY, 12110, US

(21) Appl. No.: 11/338,489

(22) Filed: Jan. 24, 2006

Related U.S. Application Data
(60) Provisional application No. 60/646,360, filed on Jan. 24, 2005.
(60) Provisional application No. 60/708,939, filed on Aug. 17, 2005.

(51) Int. Cl. A01K 39/01

(52) U.S. Cl. 119/52.3

(57) ABSTRACT

A bird feed having a user adjustable feed path mechanism adjusted by controlling the distance between the feeder and the receiving element for the feed. The invention can incorporate a cage to prevent the retrieval of food from squirrels when incorporated into a birdfeeder.

### CROSS REFERENCE TO RELATED APPLICATIONS

This application claims benefit to U.S. Provisional No. 60/646,360 filed on Jan. 24, 2005 and U.S. Provisional No. 60/708,939 filed on Aug. 17, 2005 the contents of both are incorporated in their entirety.

### BACKGROUND

The hobby of bird watching is thousands of years old. Man has been feeding birds to attract them to get them to come close enough to watch. The placement of food outside presents problems with storage and handling. Sufficient quantities of food to feed the birds for an extended period requires methods of storage and presentation that will attract the birds and defeat unintended guests such as squirrels or other rodents.

The method of defeating squirrels from feeding has been mainly with the use of cages that would deny the squirrels head entry into the feed opening. Unfortunately this would not prevent the squirrel from using its paws to claw out seeds from the food opening. The presence of squirrels scares away birds and the food reservoir of a feeder can be emptied in hours instead of weeks.

The earlier feeders also had the problem of having a fixed seed opening diameter. This would allow quick dispensing of food regardless of size. The fixed opening gave little adjustability and can not prevent the larger species from feeding.

The instant invention address the above mentioned problems and provides other benefits.

### SUMMARY OF THE INVENTION

A first general aspect of the invention includes a feeder comprising: a food reservoir with a first opening configured for receiving feed and a second opening configured for dispensing feed; and a dispensing element configured to align with and positioned below said second opening thereby creating an annular opening to dispense feed.

A second general aspect of the invention includes a feeder that comprises a food reservoir with a first opening configured for receiving feed and a second opening configured for dispensing feed; a dispensing element configured to align with and positioned below said second opening thereby creating an annular opening to dispense feed; and a height adjustment on said reservoir to control a distance between the second opening and the dispensing element, wherein said distance between said opening is user adjustable.

A third general aspect of the invention is a device for dispensing feed comprising: a feed reservoir with at least one exit and having a first opening, wherein said first opening is user adjustable; a second feed reservoir, configured to receive feed from said first opening wherein said second seed reservoir includes a top opening; and an element configured to align with said at least one exit creating an annular opening from said reservoir to fill said second feed reservoir with food, and wherein said reservoir and said element are movable in relationship to each other thereby making said annular opening user-adjustable.

A fourth general aspect of the invention is a bird feeder comprising: a first seed reservoir; a second seed reservoir in fluid communication with the first seed reservoir; a seed platform to position and receive the second seed reservoir beneath the first seed reservoir; and an animal barrier upon said seed platform, wherein said animal barrier includes a cage having openings sufficiently large in diameter to allow at least one species of bird to feed, but sufficiently small in diameter to prevent entry of a squirrel's head.

### BRIEF DESCRIPTION OF THE DRAWINGS

FIG. 1 is a top perspective view of one embodiment of a squirrel-proof bird feeder;

FIG. 2 is top perspective view of the lower half of the bird feeder;

FIG. 3 is top perspective view of the cover removed;

FIG. 4 is a top view of bottom portion of an embodiment of a squirrel-proof bird feeder;

FIG. 5 is a front view of reservoir and dispensing element;

FIG. 6 is a top view of reservoir and dispensing element;

FIG. 7 is front elevation view of the element;

FIG. 8 is front elevation view of the element;

FIG. 9 is front elevation view of the element;

FIG. 10 is front elevation view of the element;

FIG. 11 is a top, perspective view of an embodiment of the squirrel-proof bird feeder;

FIG. 12 is a close up elevation view of lower portion of an embodiment of the squirrel-proof bird feeder;

FIG. 13 is an elevation view of an embodiment of the squirrel-proof bird feeder;

FIG. 14 is a side view of the squirrel-proof bird feeder;

FIG. 15 is a close-up view of dispensing element height setting indicia of an embodiment of the squirrel-proof bird feeder;

FIG. 16 is a front elevation view of an embodiemnt of the squirrel-proof bird feeder;

FIG. 17 is a close-up, elevation view of lower portion of the reservoir of an embodiment of the squirrel-proof bird feeder;

FIG. 18 is a sectional side view of interplay of handle ends, opening on housing, openings on reservoir side showing the creation of a user adjustable seed path opening;

FIG. 19 is a close-up, bottom view of secondary seed reservoir of an embodiment of the squirrel-proof bird feeder;

FIG. 20 is a close-up, top view of secondary seed reservoir of the squirrel-proof bird feeder;

FIG. 21 is a close-up, top perspective view of secondary seed reservoir of the squirrel-proof bird feeder;

FIG. 22 is a close-up, top perspective view of secondary seed reservoir of the squirrel-proof bird feeder;

FIG. 23 is a close-up, side elevation view of secondary seed reservoir of the squirrel-proof bird feeder having upward angled lip edges;

FIG. 24 is a close-up, perspective view of seed reservoir of the squirrel-proof bird feeder;

FIG. 25 is close-up, top perspective view of an embodiment of the primary and secondary seed reservoirs of the bird feeder without the cage;

FIG. 26 is a close-up, side elevation view of the squirrel-proof bird feeder without the primary seed reservoir.

### DETAILED DESCRIPTION OF THE INVENTION

The invention is a feeder that can effectively hold and dispense different size and types of food for automatic feeding of animals while selectively preventing other species. In one embodiment it is a squirrel-proof bird feeder to dispense bird seed. When used as a bird feeder it may be adjustable because bird seed comes in a variety of types. The seed used in feeders can either be one species/type of seed or a mix of seed types/species. Each type of seed has a size, shape, and diameter of the seed kernels. The present invention has an aspect that allows the user to adjust the discharge opening, or exit, so as to compensate for the particular size and type of feed or seed being dispensed from the feeder. In this manner, when the feeder is adequately adjusted, the feed does not dispense too quickly, nor too slowly, nor does the seed become clogged in the feeder.

There are several ways to accomplish this adjustability aspect of the invention. Clearly, there are aspects of the invention that can be used throughout any of these embodiments, as well as, others (not shown).

A squirrel-proof bird feeder in the present invention includes a seed reservoir with at least two openings; one for introducing seed to the reservoir; and, the second for exit, or egress, of the seed from the reservoir. Located adjacent to this second opening (i.e., exit) is a dispensing element. The dispensing element can take on a myriad of shapes, configurations, positions with the second opening. The dispensing element may be connected to, adjacent to, abut, be displaced from, touch, etc. to the second opening. However, the dispensing element and second opening are user adjustable, wherein either one of these parts (i.e, dispensing element and second opening), or both of these parts, are user adjustable in relationship to each other so as to define an egress path/avenue from the reservoir for the seed so that the path size/configuration/shape, etc. is adjustable depending on the particular type of seed/seed mix that is in the reservoir at that time.

Further, the bird feeder may include a type of indicia that allows the user to determine what particular setting is suitable for the particular type of seed/seed mix that is in the reservoir. In this manner, a user can when using niger seed, for example, read the indicia in order to readily determine, with ease, what adjustments are required in order to set the dispensing element and second opening in suitable arrangement for niger seed.

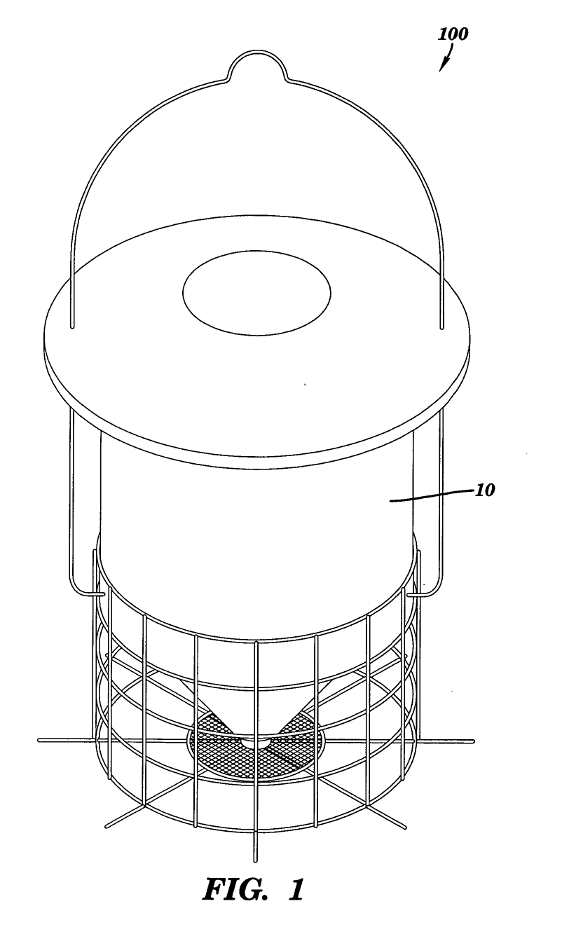

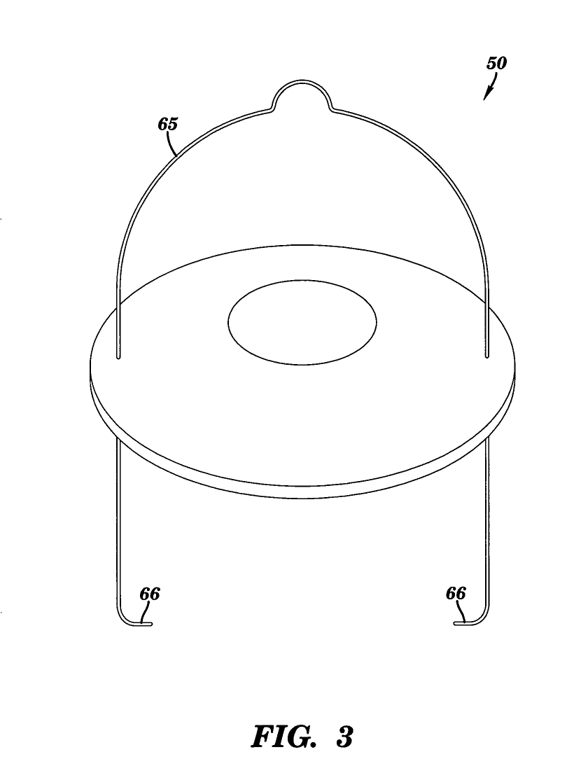

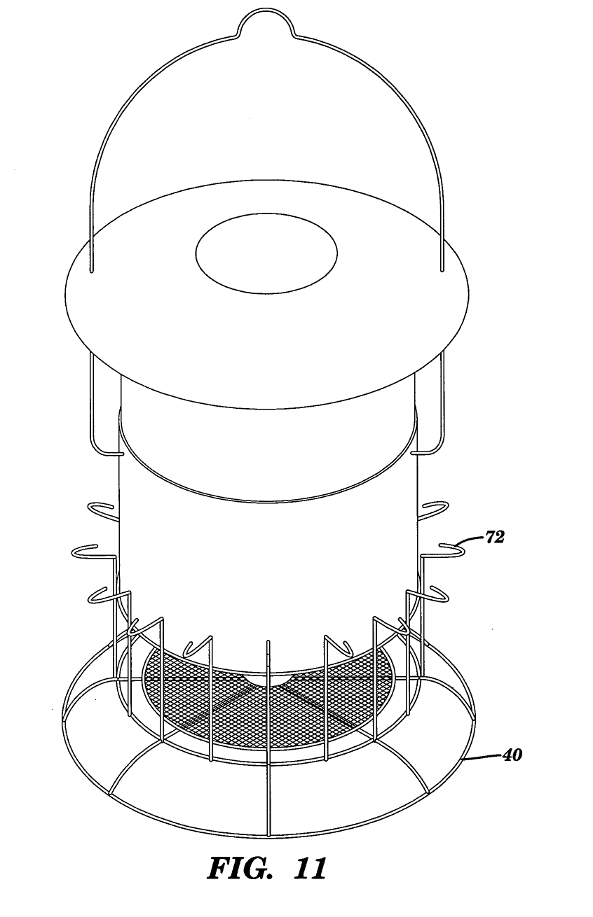

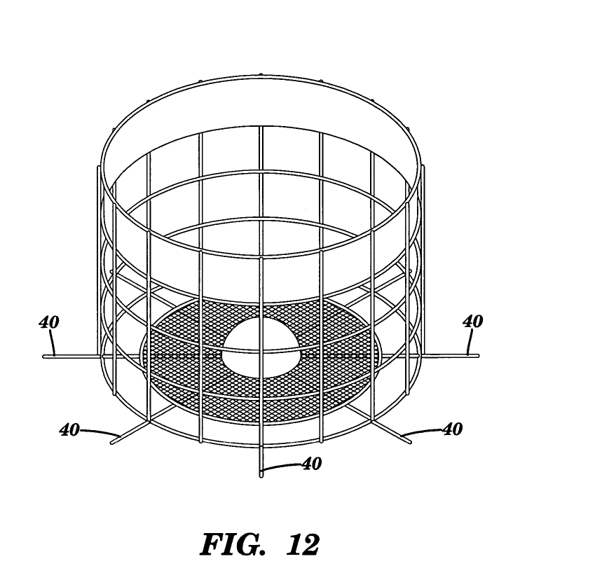

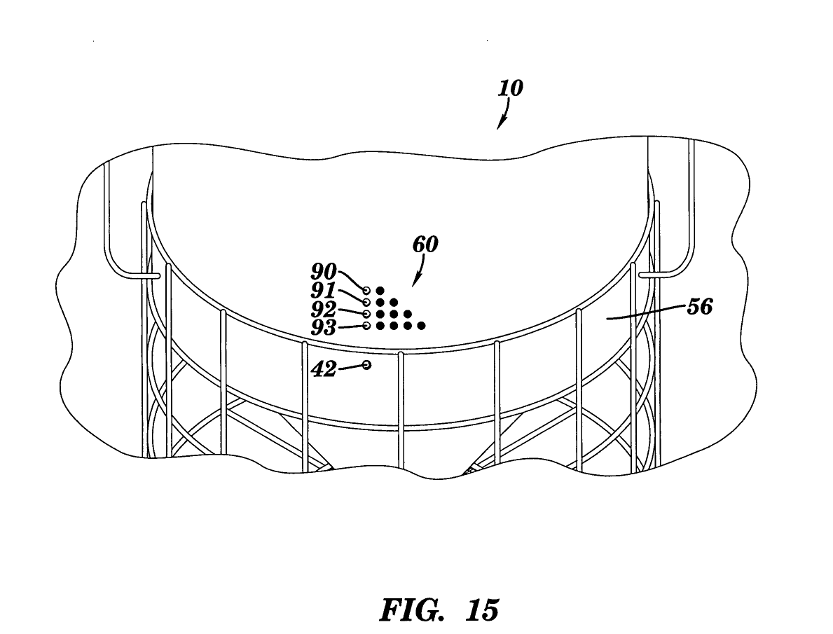

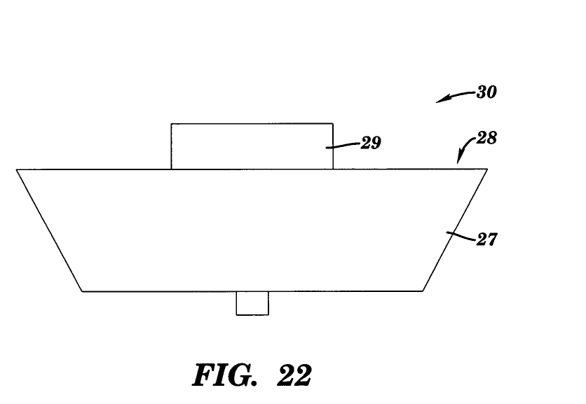

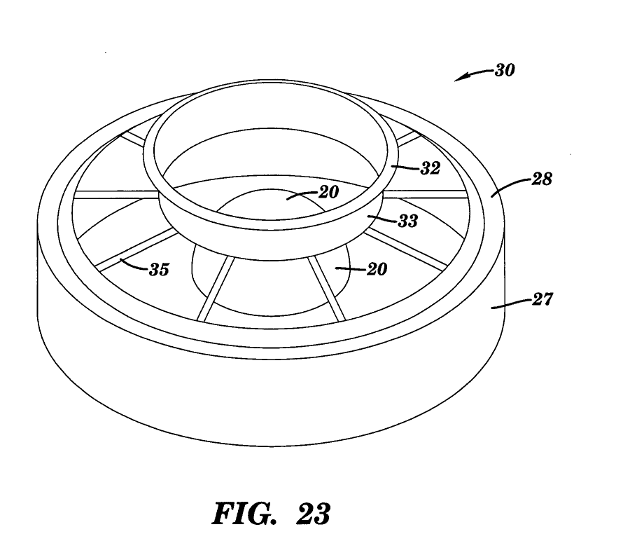

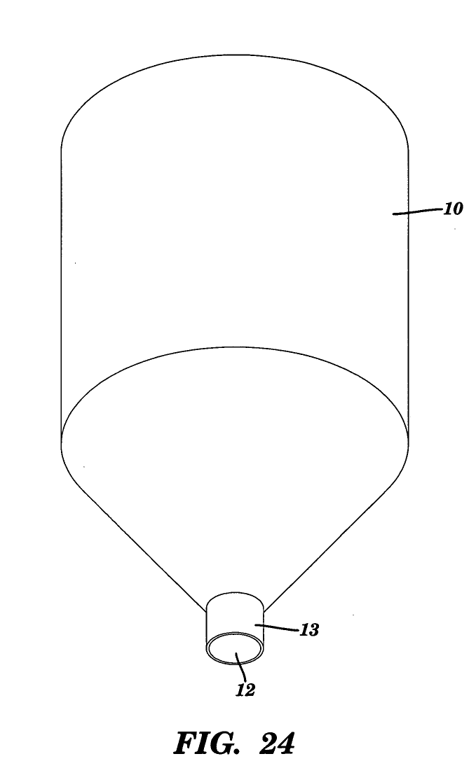

Now showing the various embodiments depicted in the various FIGS. 1-26 shows various features and embodiments with FIG. 1 showing a fully assembled squirrel-proof bird feeder. The feeder 100 includes a cover 50 through which is a handle 65 for hanging or attaching the feeder 100 to a structure (not shown). At either end of the handle 65 are ends 66 that interact with openings 68 (see e.g., FIG. 15) to allow the use of indicia 60 such as pictographs relating to specific species of birds or seed types (see e.g., FIG. 15) for one to use when adjusting the feeder or adding more feed.

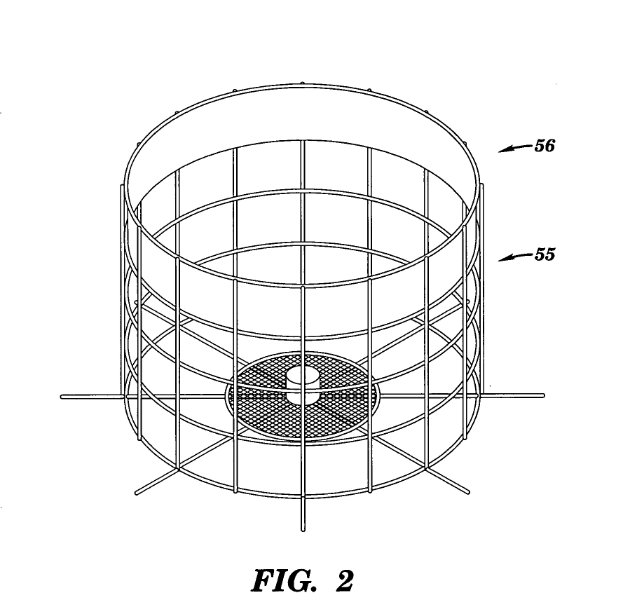

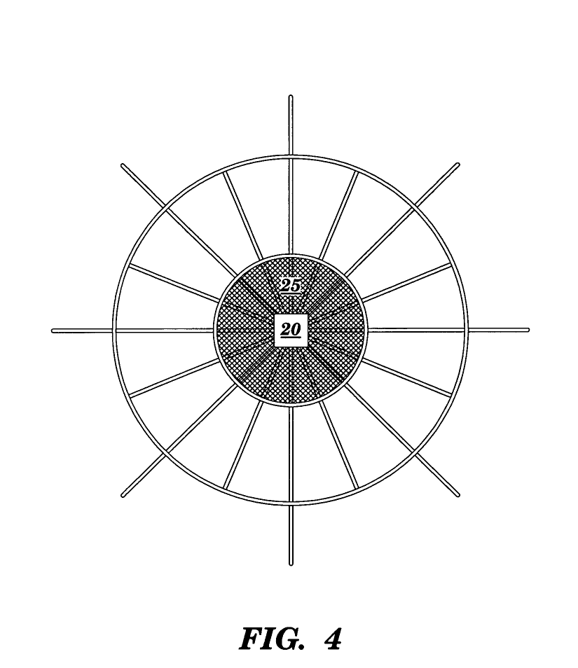

FIG. 2 shows the feeder 100 with the cover 50 and reservoir, or main seed reservoir, 10 removed for clarity purposes. Remaining is a cage system 55 and housing 56 that are sized properly to receive the reservoir 10. The housing 56 also serves a function of keeping the rain and other precipitation from getting on any seed that has been dispensed to a seed platform 25. Further shown in FIG. 4 is a view down into the center of the cage system 55 wherein at the base are the seed platform 25 and dispensing element 20 in the center thereof. Note that in any embodiment that the seed platform 25 with dispensing element 20 can be removable from the feeder 100 so as to facilitate the cleaning of the platform 25 of any debris.

The cage system 55 is sized and configured so as to prevent any squirrel from reaching the seed on the seed platform 25, thereby rendering the feeder 100 squirrel-proof The cage system 55 can further be sized and configured so that, if desired, large birds (e.g., crows, ravens, and the like) are prevented from gaining access to the seed platform 25.

The reservoir 10 includes a first opening 11 for placing seed in the reservoir 10. At the lower end of the reservoir 10 is a second opening 12 from which the seed is dispensed, or exits. Thus, by gravity, the seed goes from the reservoir 10 out the opening 12 to either a seed or feeding platform 25 or directly to the bird's beak. The shape of the inside of the reservoir 10 or second opening 80 may include a frustro-conical lower section thereby preventing any seed from staying or getting stuck within the reservoir 10. The seed (feeding) platform 25 includes a dispensing element 20 that can be a variety of shapes, sizes, and/or configurations. The dispensing element 20 interacts with, and is adjacent to, the second opening 12, thereby effectively creating, or defining, a seed “path” 15. The seed path 15 is then in fluid communication between the first reservoir 10 and the second reservoir as the food flows by gravity feed. When either the bird or other intended animal eats seed and clears at least a portion of the seed path 15 of food then additional food flows from the reservoir 10 to replenish the supply.

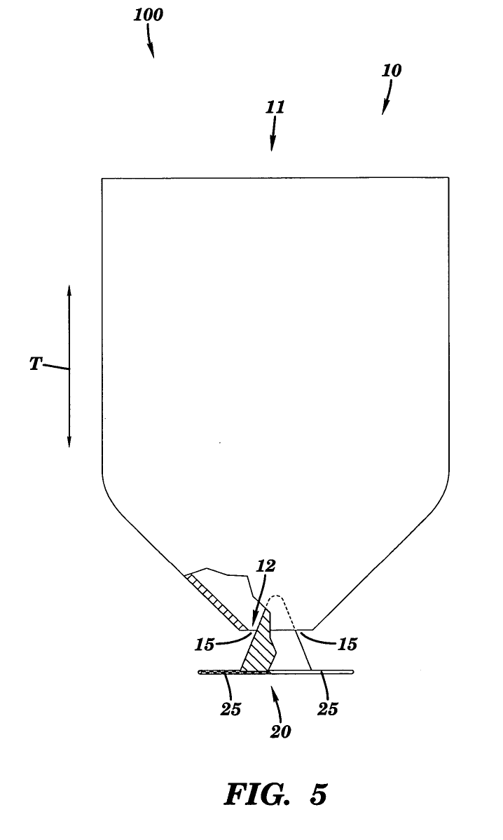

As can be seen in FIG. 5, the reservoir 10 is adjustable in the vertical direction (see directional arrow “T”). In this manner the reservoir 10 can be lowered, or raised, in relationship to the dispensing element 20. As a result the size and width of the seed path 15 created between the opening 12 and the dispensing element 20 is user-adjustable. Thus, the path opening 15 can be changed to suit the particular seed, or seed mixture, that is placed in the reservoir 10. For example, if a large seed, such as striped sunflower seed, is used in the reservoir 10, a larger path 15 would be desirable. Thus, the reservoir 10 would be raised to enlarge the path 15. Contrastingly, if thistle seed is used in the reservoir 10, a smaller path 15 would be required. The reservoir 10, in this case, would be lowered in order to diminish the size of the path 15.

Note that while the embodiment shown depicts a dispensing element 20 that is conical in shape, other shapes and configurations of dispensing elements 20 may be used. For example, the element 20 may be frustro-conical, or a right cylinder. The shape of the dispensing element 20 in other embodiments is hemispherical and other shapes and configurations too can be used wherein they match or correspond to the shape and size of the lower opening 12.

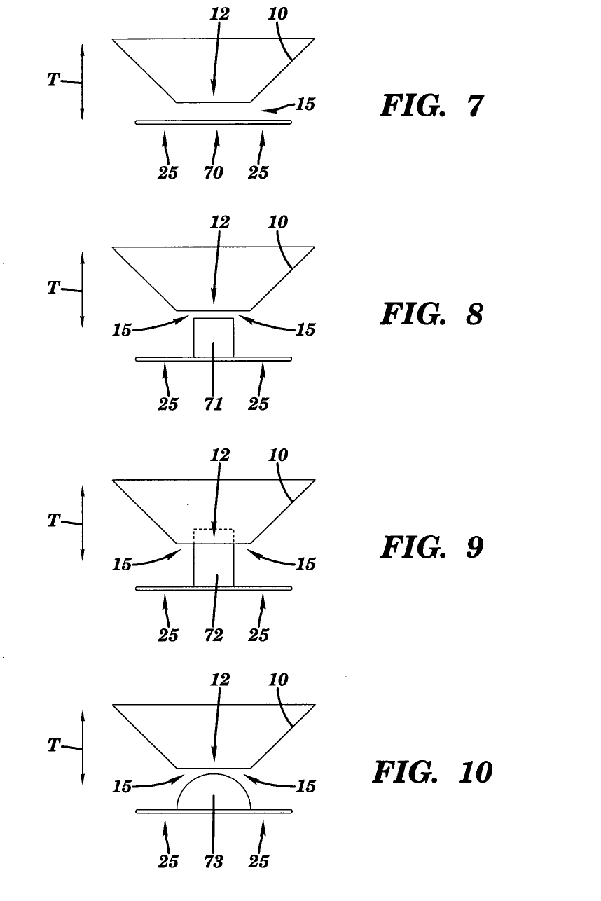

Only some examples of other configurations of dispensing elements 20 are depicted in FIGS. 7-10. In FIG. 7, the dispensing element 70 is integrated with the platform 25. That is, the platform 25 may be solid, or semi-solid, so that a portion of the platform 25 can act as the dispensing element 70, thereby effecting the opening 12 so as to create the seed path 15. Meanwhile, FIGS. 8 and 9 show an element 71 or 72 that is a right cylinder or rhombus. As can be seen by the phantom lines in FIG. 10, the element 73 in this embodiment partially enters into the lower opening 12 thereby creating an annular opening for the path 15. Note however, the element 71 shown in FIG. 8, wherein the element 71, in this embodiment also is a cylinder, need not project into or within the reservoir 10 proper. That is the elements 20 or 71-73 may be adjacent to and/or abuts to the opening 12. Finally, FIG. 10 depicts an embodiment wherein the size of the path 15 is still user-adjustable, while the dispensing element 73 is hemispherical in shape. With a hemispherical element 73, a variety of sizes are possible. The bottom width of the element 73 can be in the range of approximately 1″ to 2″ in width. Further, the height of the element 73 can be in the range of approximately ½″ to 1″ in height.

Clearly, the element 20 or 70-73 can be of various shapes, sizes, and configurations to suitably make a seed path 15. Similarly, the adjustability of either the reservoir 10, the element 20, or both is shown by the motion arrows “T”. Suitable widths for the opening 12 are in the range from approximately ¾″ to 1½″.

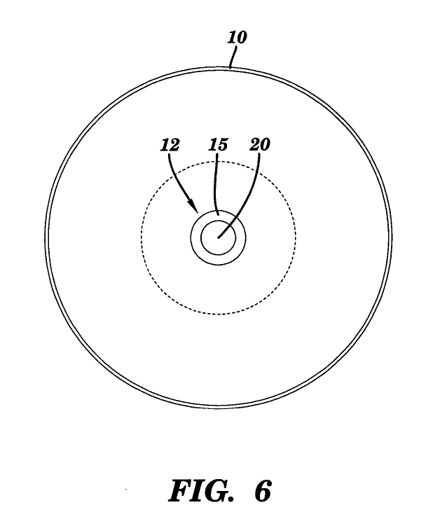

FIG. 6 shows a top view down into the reservoir 10 wherein the interplay between the dispensing element 20 and the second opening 12 creates the seed path 15, in this case an annular opening.

Note that the adjustment of the seed path 15 size may be caused by either the movement of the reservoir 10, the dispensing element 20, or both in relationship to the other.

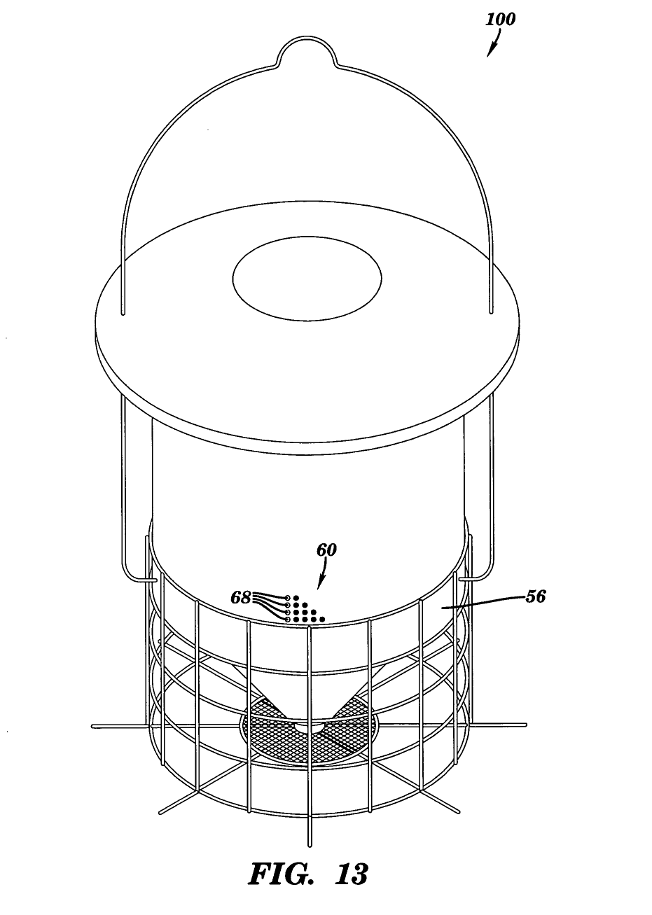

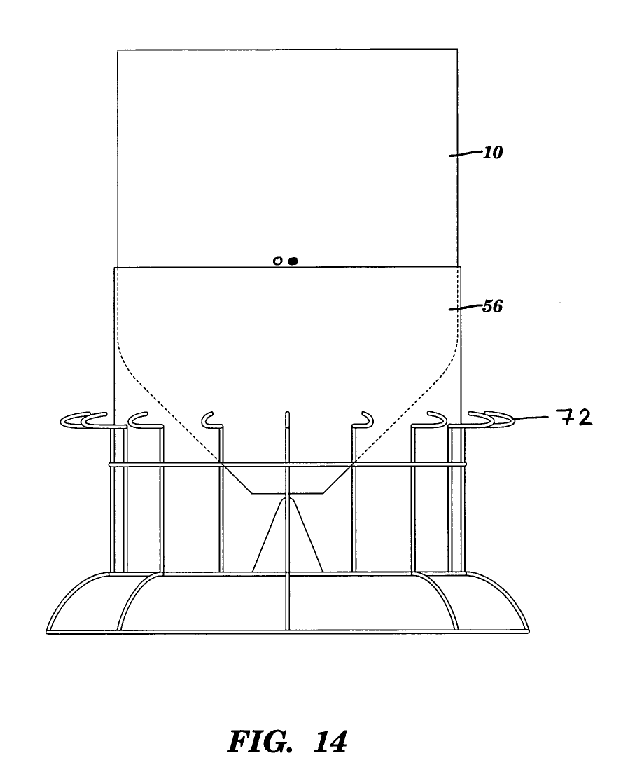

A plurality of openings 68 are extending longitudinally along the side of the reservoir 10 are shown in FIGS. 13 and 14. Alongside the openings 68 are indicia to indicate which opening 68 corresponds with a particular seed, or seed mix, type. Further on the extending through the housing 56 are openings therethrough. Thus, by aligning the ends 66 of the handle 65 through both the openings in the housing 56 and the desired indicia opening 68 the handle ends 66 can fix the height of the reservoir 10 in relationship to the dispensing element 20 below. By doing this, the user can adjust and fix the reservoir 10 in relationship to the dispensing element 20 to as to obtain a particular desired seed path 15.

In FIG. 15 is a plurality of detents 90, 91, 92 and 93 that corresponds to ball and spring 42 that allows movement of the height of the seed path 15 without using the handle ends 66 that are attached to cage 56 only instead of the reservoir. Also shown is the optional indicia showing either size of opening or type of seed. The handle 65 and its ends 66 are then relocated to another portion such as the housing 56 and then there would be no interaction involving the seed path. There are many equivalent methods known to one skilled in the art to adjust the distance between the two bodies (housing and element) to change the seed path 15. There could be notches or receiving portions between the body and the housing to allow the height to be changed and then the two bodies rotated with respect to each other to maintain the displace of the seed path 15.

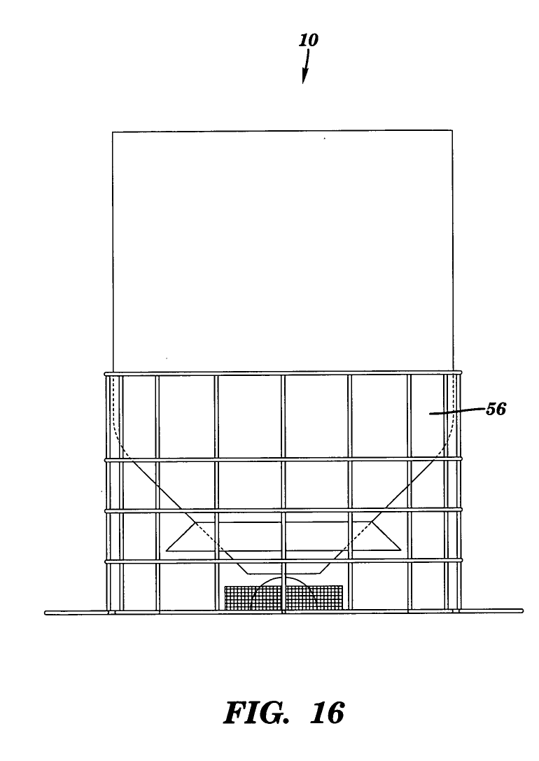

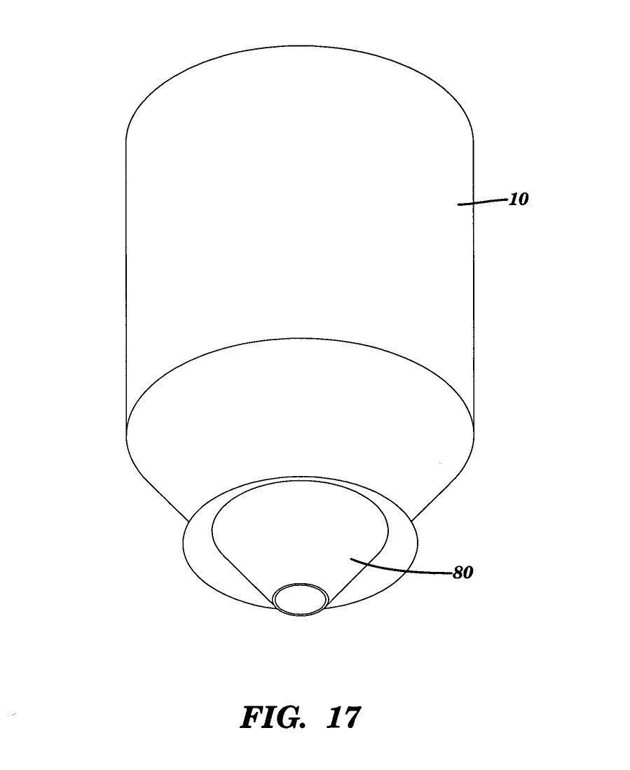

Another embodiment of the squirrel proof reservoir is shown assembled in FIG. 16. In FIG. 17 the primary seed reservoir is shown removed from the lower housing of FIG. 16. The primary seed reservoir has a lower downward facing cone to prevent unintended moisture from dripping onto either the secondary seed reservoir or onto the dispensing element to maximize the life of the seeds.

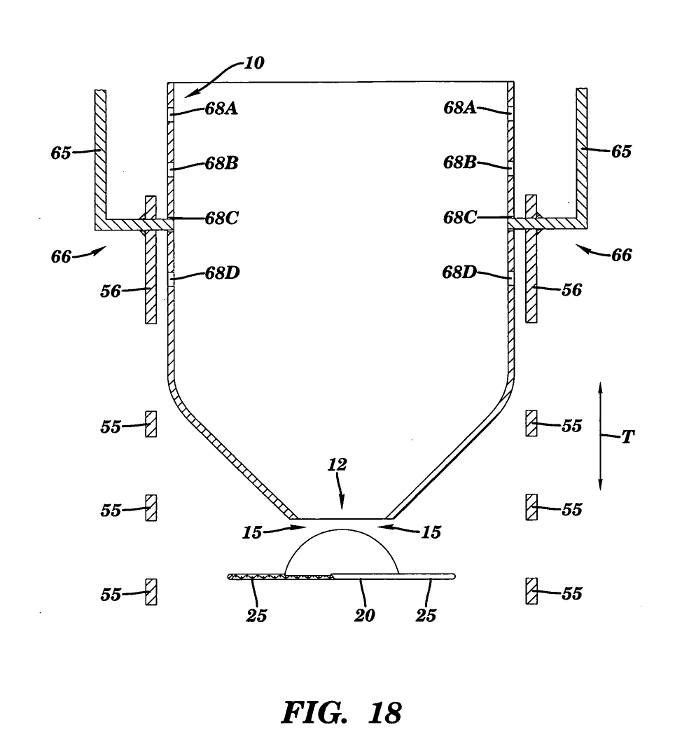

FIG. 18 shows a sectional view of the interplay when the handle end 66 is used to control the seed path separation. For example, in FIG. 18 the ends 66 are placed through the openings in the housing 56, and in its current setup, through openings 68C on the reservoir 10. The other openings 68A, 68B, and 68D are available to allow vertical adjustment of the reservoir 10 and the second opening 12. This, in turn allows for adjustability of the particular seed path 15 desired that is created between the juxtaposition of the second opening 12 and the dispensing element 20 or elements 70-73.

Clearly other methods and ways to obtain indicia and to fix the second opening 12 to dispensing element 20 at a predetermined configuration are available within this invention. For example, a ball and detent system could be used in lieu of discrete openings as shown in FIG. 15.

Further shown in FIG. 14, for example, are additional extensions 72 which can provide for hooking of suet, and the like.

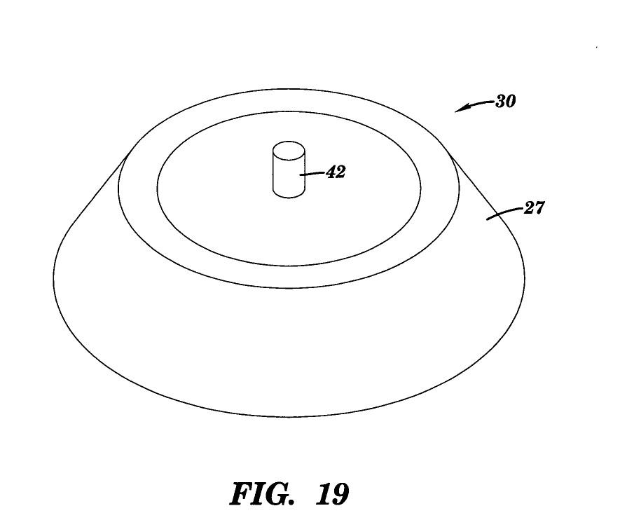

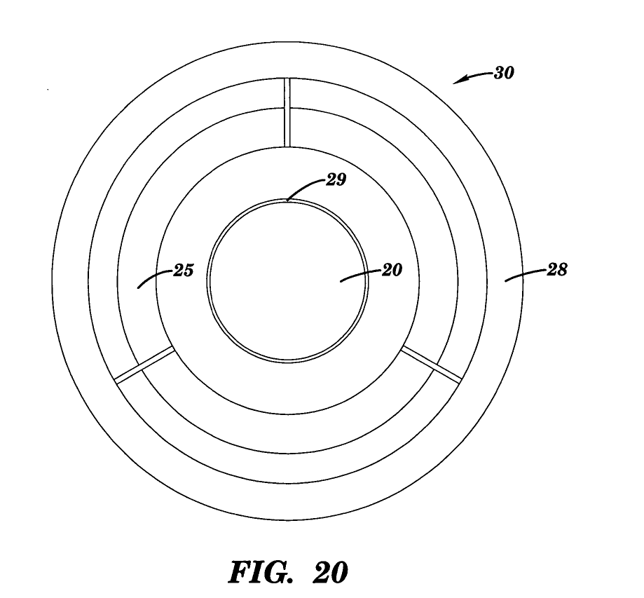

FIGS. 19 through 26 depict various views of another embodiment of the bird feeder 100 having a second reservoir 30. This embodiment of feeder 100 in addition to the main seed reservoir 10 includes a secondary seed reservoir 30 in lieu of only a seed platform 25.

The secondary seed reservoir 30 may be fixed, or removably attached, to the feeder base. The secondary seed reservoir 30 may also able to rotate if a squirrel is attempting to remove seeds with their paws to further prevent seed removal. For example, as the view in FIG. 19 shows, the bottom side of the secondary seed reservoir 30 may include a alignment pin 42 that may be received in a hole in the base of the feeder 100. This assists in allowing the user to remove the secondary seed reservoir 30 for periodic cleaning. Also the pin 42 may allow the secondary seed reservoir 30 to rotate.

As the various figures show, the secondary seed reservoir 30 receives the seed from the above located main seed reservoir 10. Once the seed leaves the second opening 12 and goes through the seed path opening 15 created by the dispensing element 20, the seed deposits on the seed platform 25 within the secondary seed reservoir 30.

The secondary seed reservoir 30 includes the seed platform 25 that is typically on the bottom of the reservoir 30 and a vertical element, or wall, 27 surrounding the seed platform 25. At the top of the wall 27 is a lip 28, or other suitable horizontal element that aids in preventing any errant seed from escaping the reservoir 30.

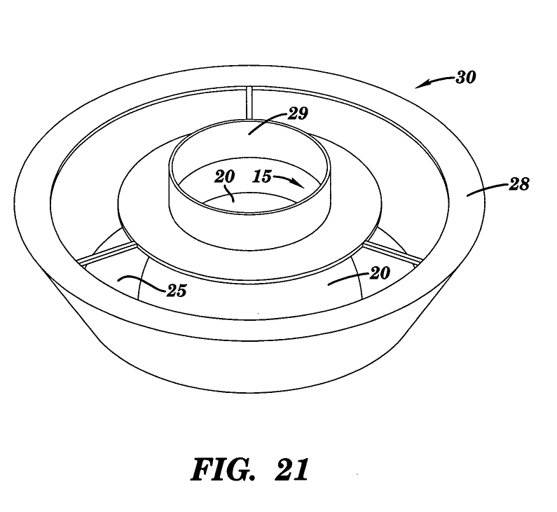

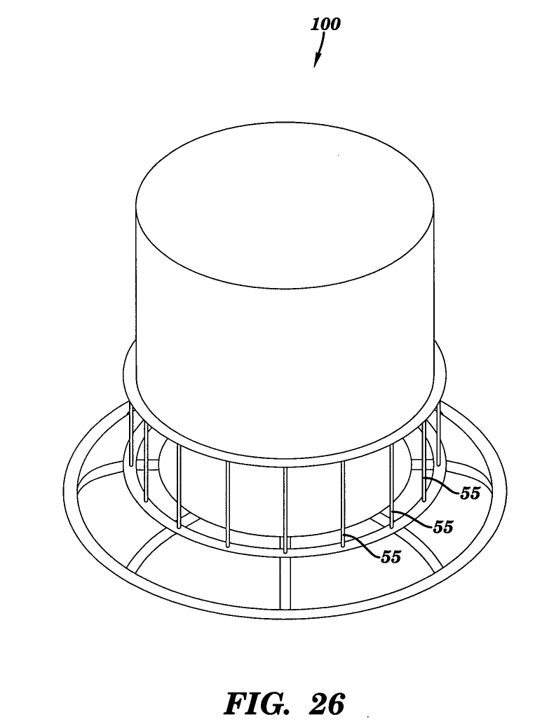

The lip 28, in particular, assists as a further preventative element in disallowing any squirrels, or similar rodents, from reaching within the caging 55 (see e.g., FIG. 21-25 with flat lip 28) with their paws and grabbing/pulling/pushing, etc. the seed out of the reservoir 30. The lip 28 may include a horizontal, angled, or other suitable surface to prevent the seed from leaving the reservoir 30. The upward angled lip 28 is shown in FIG. 26 that is even more effective for preventing scraping of seeds from the reservoir 30.

FIG. 26 displays another embodiment of the second seed reservoir 30 designed to further prevent squirrels, or similar rodents, from gaining access to the seed located on the seed platform 25, or within the second seed reservoir 30. The embodiment includes a structure, or cage, 32 operatively attached to either the wall 27 or the lip 28 of the second seed reservoir 30. The cage 32 may be made of metal, plastic, or any other material suited for the intended purpose. The cage 32 includes a plurality of concentric circles 33 that may decrease in diameter as their height above the lip 28 increases, with the smallest circle being large enough to accommodate the main seed reservoir 10 (see FIG. 1). The cage 32 also includes at least one connecting element 35 that intersects each individual circle, and serves to support the plurality of concentric circles 33. Additional connecting elements 35 may be used such that the cage 32 forms a grid over the second seed reservoir 30. The slope of each connecting element 35 that results from intersecting the plurality of circles 33 as they decrease in size as height above the lip 28 increases may be in the range of approximately 0 to 45 degrees. In the illustrated embodiment, the slope of each connecting element 35 is approximately 30 degrees. Furthermore, the plurality of concentric circles 33 may be situated such that each individual circle is approximately ⅝ of an inch to ¾ of an inch apart. This configuration is ideal for preventing a squirrel, or other such rodent, from being able to place their head within the reservoir 30 in order to obtain the seeds therein.

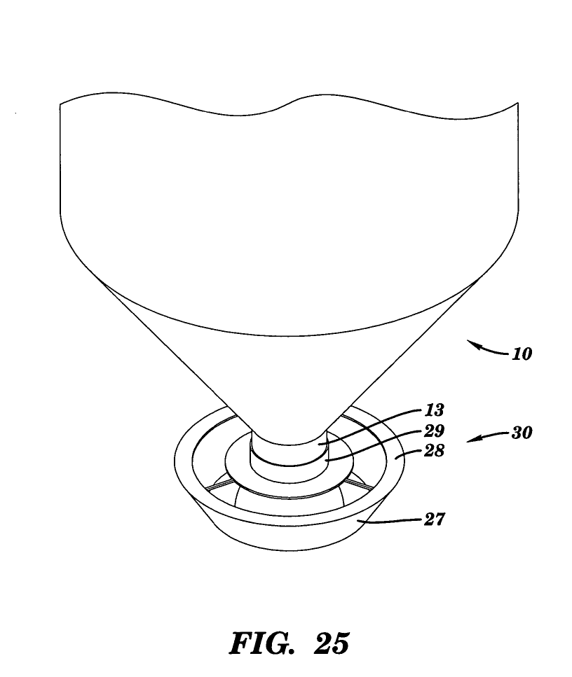

There are various means that the reservoir 30 may be attached to the feeder 100, or portions thereof. One such means, is shown, in particular, in FIG. 25. The bottom end of the main seed reservoir 10 includes an opening extension 13 at the second opening 12. The opening extension 13 mates with an extension 29 (see. e.g, FIGS. 20-22) on the upper portion of the secondary seed reservoir 30. In this manner, (see FIG. 25), both the main seed reservoir 10 and secondary seed reservoir 30 are joined. Thus, seed (not shown) leaves the main seed reservoir 10 and exits the second opening 12. The seed then passes through the seed path/opening 15 (see. FIG. 21) that is created between the dispensing element 20 and the collar, or extension 29 opening.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

I claim:

1. A feeder comprising:
a food reservoir with a first opening configured for receiving feed and a second opening configured for dispensing feed; and
a dispensing element configured to align with and positioned below said second opening thereby creating an annular opening to dispense feed.

2. The feeder of claim 1 further comprising:
a feeding platform wherein the dispensing element is positioned thereupon.

3. The feeder of claim 1 further comprising:
a frusto-conical portion of the food reservoir wherein the second opening has a smaller diameter than the first opening.

4. The feeder of claim 1 further comprising:
a cage to surround said dispensing element;
a housing attached to said cage to receive said food reservoir;
a removable lid positionable over the first opening of the food reservoir to prevent contamination of the feed; and
a handle attached to the feeder.

5. A feeder comprising:
a food reservoir with a first opening configured for receiving feed and a second opening configured for dispensing feed;
a dispensing element configured to align with and positioned below said second opening thereby creating an annular opening to dispense feed; and
a height adjustment on said reservoir to control a distance between the second opening and the dispensing element, wherein said distance between said opening is user adjustable.

6. The feeder of claim 5 further comprising:
a cage to surround said dispensing element;
a housing attached to said cage to receive said food reservoir;
a removable lid positionable over the first opening of the food reservoir to prevent contamination of the feed; and
a handle attached to the food reservoir.

7. The feeder of claim 6 further comprising:
a platform tray to contain said dispensing element.

8. The feeder of claim 7 further comprising:
an inner facing outer lip portion of the platform tray to prevent scraping of seeds onto the ground by paws of rodents.

9. The feeder according to claim 5 further comprising:
a second seed reservoir, wherein said second seed reservoir is filled by the flow of feed from the dispensing element.

10. A device for dispensing feed comprising:
a feed reservoir with at least one exit and having a first opening, wherein said first opening is user adjustable;
a second feed reservoir, configured to receive feed from said first opening wherein said second seed reservoir includes a top opening; and
an element configured to align with said at least one exit creating an annular opening from said reservoir to fill said second feed reservoir with food, and wherein said reservoir and said element are movable in relationship to each other thereby making said annular opening user-adjustable.

11. The feeder of claim 10 further comprising:
a cage having a plurality of openings smaller than a squirrel's head to surround said element;
a housing attached to said cage to receive said feed reservoir;
a removable lid positionable over a first opening of the feed reservoir to prevent contamination of the feed; and
a handle attached to the feed reservoir.

12. The feeder of claim 11 further comprising:
at least one perch positioned outside of the cage.

13. The feeder of claim 12 further comprising:
a platform tray to contain said element positioned from the opening of the cage within reach of a bird, but so that the element can not be reached by a squirrel.

14. The feeder of claim 13 further comprising:
a upward angled inner facing outer lip portion of the platform tray to prevent scraping of seeds onto the ground by paws of rodents.

15. The feeder of claim 10 wherein the element has a profile selected from the group consisting of substantially flat, cubical, elongated rhombus, and at least portion of a sphere.

16. A bird feeder comprising:
a first seed reservoir;
a second seed reservoir in fluid communication with the first seed reservoir;
a seed platform to position and receive the second seed reservoir beneath the first seed reservoir; and
an animal barrier upon said seed platform, wherein said animal barrier includes a cage having openings sufficiently large in diameter to allow at least one species of bird to feed, but sufficiently small in diameter to prevent entry of a squirrel's head.

17. The bird feeder of claim 16 further comprising:
a lip surrounding the second seed reservoir to prevent seed removal by a rodents paw.

18. The feeder of claim 16 further comprising:
at least one perch positioned outside of the cage.

19. The feeder of claim 16 further comprising:
a first opening on the first seed reservoir;
a funnel portion of the first seed reservoir;
a second opening beneath the funnel portion of the first seed reservoir to transfer seed to the second seed reservoir;
a housing attached to said cage to receive said first seed reservoir;
a removable lid positionable over the first opening of the seed reservoir to prevent contamination of the seed; and
a handle attached to the feeder.

20. The feeder of claim 19 further comprising:
an element positioned between the second opening of the first seed reservoir and within the second seed reservoir to control flow of seed between reservoirs by adjusting the seed path wherein the element has a profile selected from the group consisting of substantially flat, cubical, elongated rhombus, and at least portion of a sphere.
